(19) United States
(12) Patent Application Publication
(10) Pub. No.: US 2003/0230884 A1
(43) Pub. Date: Dec. 18, 2003

(54) 4X motorized suspension system frame with steering and forward and reverse drive capability

(76) Inventor: Byron De Wayne Barber, Saluda, VA (US)

Correspondence Address: Byron D. Barber, P.O. Box 1490, Saluda, VA, 23149, US

(21) Appl. No.: 10/170,255

(22) Filed: Jun. 13, 2002

(51) Int. Cl. B62D 21/00

(52) U.S. Cl. 280/781

(57) ABSTRACT

A frame structure designed to accommodate magnetic electric motors for the purpose of altering the distance of the main frame, from a ground level position to a vertically raised position, vertically above the wheel axles at main frame bottom level.

Four motors are mounted to the upright motor mounts located in the passenger compartment of the vehicle. These motors are positioned in close proximity to each road wheel to enable individual raising or lowering of each 1 of 4 of the vehicles leading corner edges, located at the front and rear of the vehicle. The front of the frames contact plate is designed for mounting of a servo motor to facilitate steering of the vehicle in right or left turns. The rear contact plate is designed to accommodate a motor for the drive train to facilitate forward and reverse drive capability. Energy is supplied by a battery powered control enclosure connected to various motors mounted to frame structure with electrical wire, or wireless remote control. Frame can be constructed from a number of materials, such as aluminum, mild steel, titanium, carbon fiber, stainless steel or plastic. Frame sets can be welded together using measured precut pieces, or frame parts can be produced by a C.N.C. punch press machine, and formed to specifications by use of a break press. Plastic frames may be produced through the use of injection molds. These are some of the most common forms of frame manufacturing that can be used.

### CROSS REFERENCES TO RELATED APPLICATIONS

| | | | |
|---|---|---|---|
| 5,306,038 | April 1994 | Henderson, Jr. | 280/688 |
| 5,334,077 | August 1994 | Bailey | 446/466 |
| 5,527,059 | June 1996 | Lee, Jr. | 280/688 |
| 5,643,041 | July 1997 | Mokaida | 446/455 |
| 2,054,842 | June 1933 | Walker | |
| 5,322,469 | June 1994 | Tilbor | 446/454 |
| 4,457,101 | July 1984 | Matsushiro | 446/456 |
| 4,892,503 | January 1990 | Kumazawa | 446/456 |
| 4,183,174 | January 1980 | Barns | 46/254 |

### BRIEF SUMMARY OF THE INVENTION

The present invention is a frame structure constructed of any one of a number of materials used separately to build a 4×-suspension system frame. The most favorable material due to it's ductile strength and light weight to be used, is aluminum 5052, 094 thick. The second best material is carbon fiber, third is plastic, fourth is steel, and fifth is mild steel. The sixth is titanium that is the best material to use for the frame due to its superior strength and light weight. The most unfavorable quality of titanium would be its high price, compared to the other mentioned materials.

Methods of construction would vary according to material used for the frame. In the case of an aluminum frame set the parts would be punched out of a sheet of aluminum by a C.N.C. punch press, then necessary bends would be made to the parts by a break press. Frame construction would be completed by a minimal amount of gas tungsten arc welding to connect certain parts of frame structure such as upright motor mounts. Carbon fiber frame sets would be cut out of a sheet of carbon fiber, and screwed together with screws, nuts, lock washers and washers. Plastic frames could be produced by use of injection molds with an upright motor mount and main frame in one piece. Stainless steel, mild steel and titanium frame sets would be constructed virtually the same as the aluminum process.

This frame structure is designed to mount 4 motors in an upright standing position, in what would be the passenger compartment of an automotive vehicle. Each one of these motors is equipped with a vertically mounted pinion screw. These are attached to the shaft of the motors and held secure by a horizontal allen screw through the head of the pinion screw. The pinion arm nut connector extension travels vertically up and down pinion screw. When electrical input is applied in forward or reverse mode by momentary toggle switches connected to each motor by way of a battery powered switch box that can be directly wired to vehicle or remotely controlled. Pinion extensions are mounted at front end to contact plate's front and rear. These extensions are held in place in close proximity near each one of four road wheels by ⅛ of an inch cable ties.

Contact plates have slotted holes in them to accommodate main frame vertical guides. These guides keep contact plates centered, and allow for vertical travel of contact plates up or down in small increments, or the total length of pinion screw.

### BRIEF SUMMARY OF THE INVENTION

The front contact plate is also used to mount the steering servo too. This enables vehicle to perform right and left turns. The servo is mounted at the front wheels by small diameter rods that mount to the front wheel swivels. The servo is operated by battery power and may be directly wired to switch box or wireless remotely operated. A motor is mounted to the rear contact plate to propel the vehicle either in forward or reverse by a pinion on the shaft of the motor, that engages with a gear mounted to one rear wheel also battery operated wired or wireless remotely controlled.

### BRIEF DESCRIPTION OF DRAWINGS

FIG. 1 is a top view of the invention of a 4×-Suspension System Frame Set with components for operating the suspension system, steering system and drive train. Also shown are the main frames, front and rear contact plates'.

FIG. 2 is a left side view of the invention of a Suspension System Frame Set. Shown in this view are the upright magnetic motors as they are mounted to the upright motor mounts. Also shown in this view is the pinion screw, coil spring and pinion nut connector extension.

FIG. 3 is a front view of the invention of a 4×-Suspension System Frame Set. The front view shows the front of the contact plate; the front of the road wheel assembly attached to the wheel swivel mounts. Also shown is the servo that is for the purpose of steering the vehicle, which is connected to the swivels by linkage rods. Also shown are the main frame vertical guides as they are positioned through the front contact plate.

FIG. 4 is a rear view of the invention of a 4×-Suspension System Frame Set. In this view the rear contact plate is shown with the drive train motor mounted to it, by use of an axle drive motor mount plate. Also shown is the drive train wheel assembly complete with wheel gear and drive motor shaft pinion. Also shown are the main frame vertical guides as they are positioned through the rear contact plate.

FIG. 5 is a drawing of the pinion torque screw, extension and pinion nut connector extension assembly.

### DETAILED DESCRIPTION

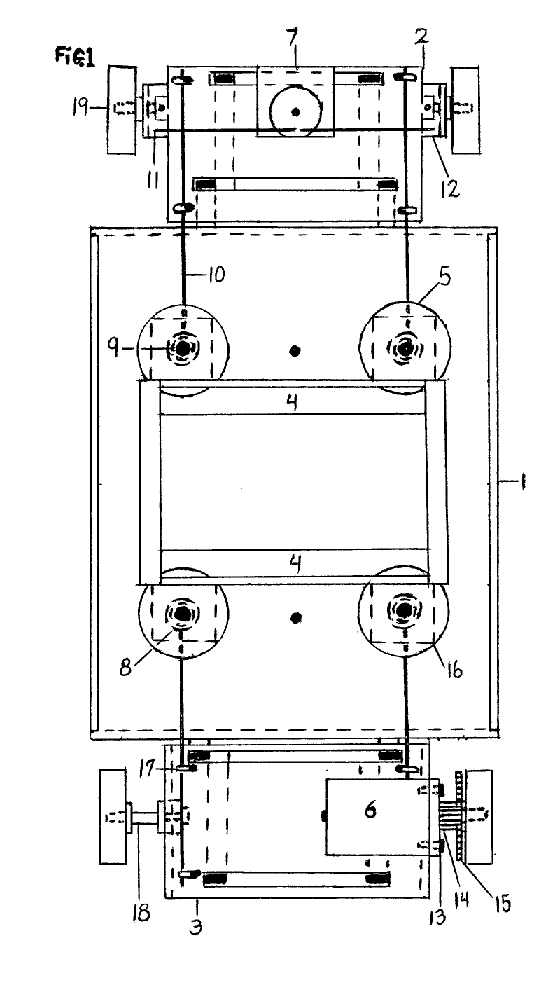

FIG. 1 is a top view looking down on the invention of frame set 1. Also shown are top views of the four suspension system magnetic motors 5 attached to the main frame 1 upright motor mounts 4. Also shown in this view is the pinion extensions 10 extending from the upright motors 5 to their mounted positions on the front 2 and rear 3 contact plates'. Front contact plate 2 also displays servo 7 mounted on front contact plate 2 with rods 11 from servo 7 extending outward to swivel mounts 12 that enable steering of front wheel 19 assembly axle studs 18 and road wheels 19. Also shown on contact plates' front 2 and rear 3 are slots for main frame 1 vertical guides. Also shown on rear contact plate 3 is drive train motor 6 pinion 14 motor and drive axle mount 13, the drive gear 15 that connects to right rear wheel 19 and makes contact with motor shaft pinion 14 which transfers energy from motor 6 to wheel 19 gear 15 to produce forward or reverse motion. This action creates momentum that propels frame structure. Servo 7 and drive train motor 6 are battery powered by wire or wireless remote control.

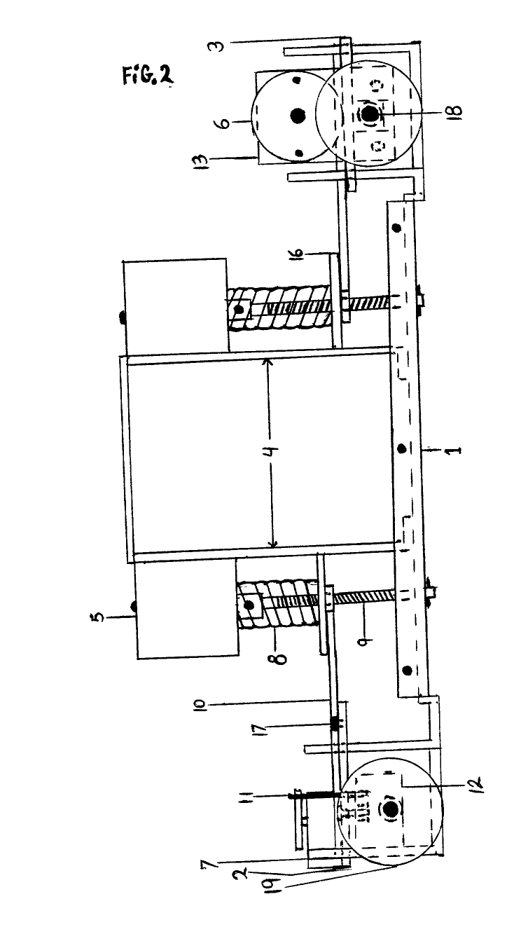

FIG. 2 is a side view of frame set structure. This view displays the relationship of frame parts and components from a side view front to rear. Shown here is a side view of the upright motors 5 as they are attached to the upright motor mounts 4. Also shown is a clear view of the pinion screws 9 and pinion nut connector extension 16 back down onto threads of pinion screw 9 once it reaches the top of pinion screw 9. Also there is a area at the bottom of the pinion screw 9 that has no threads on it to prevent tightening of pinion nut connector extension 16 against main frame 1, also once pinion nut connector extension 16 travels to its lowest point of pinion screw 9 the weight of the main frame 1 upright motor mounts 4 and magnetic motors 5 assist in reengagement of pinion nut connector extension 16 and the threads on pinion screw 9. Also shown in this view is the pinion extensions 10, cable tie 17 that secure pinion extension 10 to front contact plate 2 and rear contact plate 3, shown extending vertically from main frame 1 are front and rear contact plate guides, these allow vertical travel of the contact plates and keeps contact plates centered with main frame 1 these are bent upward by the use of a break press. Also in the case of a completely flat main frame 1 screws can be used as contact plate guides. This view also shows the side of the servo 7 and steering linkage rod 11. The rear contact plate 3 shows the rear of the forward and reverse drive motor 6 and contact plate 3 and main frame 1 vertical guides.

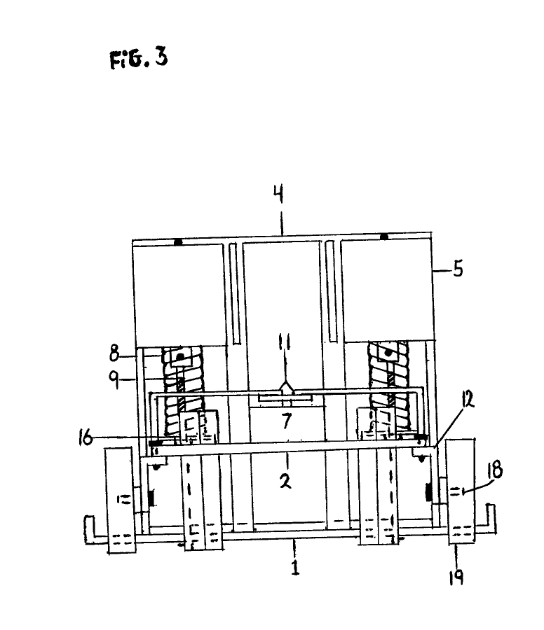

FIG. 3 shows the front end of the frame set looking at it directly in front. In this view you see across the front the distance between the upright motors 5, it shows the servo 7 in the center of the front contact plate 2, and approximately how the main frame 1 vertical guides pass through the contact plate 2 also the coil springs 8 pinion screws 9 front wheel swivels 12 are shown in relationship to the front wheels 19 assembly. It also shows the front of the upright motor mounts 4. View also shows the front of pinion nut connector extensions 16.

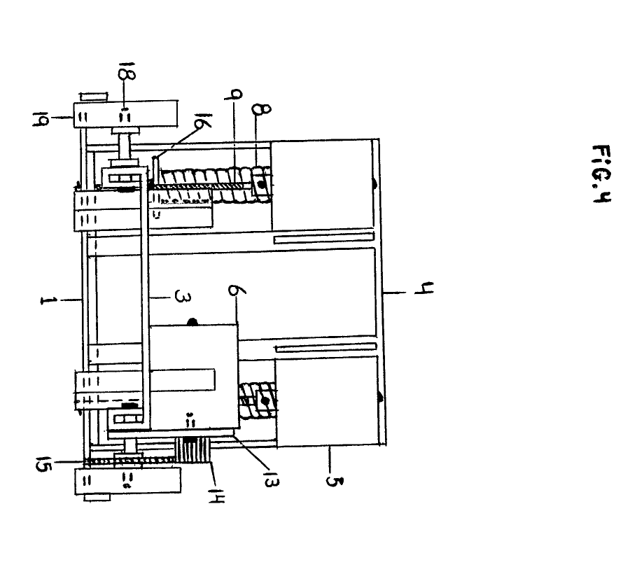

FIG. 4 is a view of the rear of the frame set structure and it's components. It shows upright motor mounts 4, upright electric magnetic motors 5, rear contact plate 3 with drive train motor 6 mounted to it by axle and drive motor mount plate 13. Pinion 14 engages with gear 15 to propel vehicle forward or in reverse. When motor is energized through wire or wireless battery powered remote control, mainframe 1 is shown from the rear with rear contact plate 3, vertical main frame 1 guides also shown are pinion screws 9, coil springs 8, axles studs 18 and wheel 19 assembly.

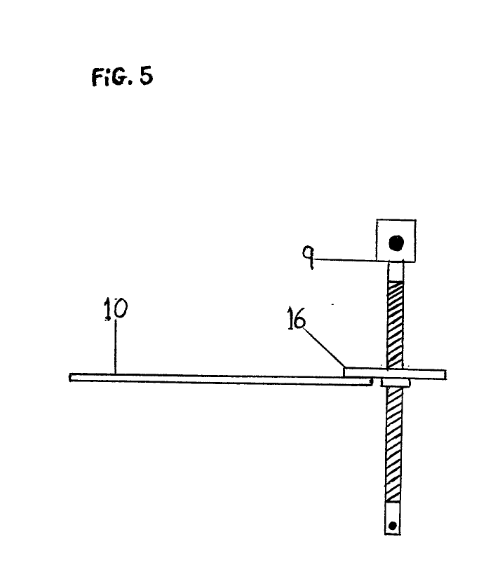

FIG. 5 shows the pinion torque screw assembly. The pinion screw 9 is hollow in the pinion and has a threaded hole through one side so that when the pinion is slid onto the motor shaft it can be secured in place by use of a allen screw through the hole located in the side of the pinion screw 9. The pinion nut connector extension 16 has a threaded hole through the center of it which facilitates vertical travel of the pinion nut connector extension 16 up or down the pinion screw 9. When up right electric magnetic motor 5 is energized in a forward or reverse circular rotation, pinion extension 10 extends outward from the pinion nut connector extension 16, and is mounted to the contact plates 2 and 3, use of a cable tie 17. This is the point at which energy from the motor results in the vertical raising or lowering of the main frame 1 structure.

The present invention is not intended to be limited to the embodiments described above, but to encompass any and all embodiments within the scope of the following claims.

I claim:

1. A frame structure comprised of 4 pieces that together complete a frame set that with other components such as electric motors, electrically wired or wireless remote control operated individual 4× suspension system vehicle, with steering and forward and reverse capability.
The main frame has upright motor mount frames, attached to the approximate center of the main frame, which is designed to accommodate 4 electric magnetic motors to raise or lower main frame corners in close proximity to a designated road wheel. The main frame has 4 vertical guides that extend from the passenger compartment of the vehicle and bend straight up at a 90-degree angle located in the front and rear of the wheel axle studs.

2. Front contact plate travels vertically up or down vertical main frame guides, steering servo is mounted on front contact plate in the center at the front edge, wheel swivels attach to both sides of front contact plate for the purpose of mounting wheels that steer the vehicle.

3. The rear contact plate supports the drive train motor and wheel assembly for the purpose of forward and reverse propulsion. Vertical guides from main frame also rise up through rear contact plate as described in claim 2, when suspension system motor is energized, vehicle wheels support vehicle as main frame raises or lowers according to the way in which motor shaft turns, be it left or right.

4. This is the claim for the pinion screw with pinion extension, and pinion nut connector extension. This is the part of the suspension system that transfers the energy of a spinning upright magnetic motor to vertically raise and lower the main frame of the vehicle from the grounded stationary position of the road wheels.
